(19) United States
(12) Patent Application Publication
(10) Pub. No.: US 2013/0153667 A1
(43) Pub. Date: Jun. 20, 2013

(54) METHOD FOR MAKING A DEVICE COMPRISING A TRANSPONDER ANTENNA ON A THIN WEB AND RESULTING DEVICE

(71) Applicants: Christophe Bousquet, La Seyne Sur Mer (FR); Jean-Francois Martinent, La Ciotat (FR); Laurence Robles, Saint Zacharie (FR); Francois Roussel, Auriol (FR)

(72) Inventors: Christophe Bousquet, La Seyne Sur Mer (FR); Jean-Francois Martinent, La Ciotat (FR); Laurence Robles, Saint Zacharie (FR); Francois Roussel, Auriol (FR)

(73) Assignee: GEMALTO SA, Meudon (FR)

(21) Appl. No.: 13/700,864

(22) PCT Filed: May 24, 2011
(86) PCT No.: PCT/EP11/58471

§ 371 Date: Feb. 18, 2013

(51) Int. Cl. H01Q 1/22; G06K 19/077; H01Q 7/00

(52) U.S. Cl. CPC H01Q 1/2216; H01Q 7/00; G06K 19/07773
USPC 235/492; 343/866; 29/600; 29/601

(57) ABSTRACT

The invention relates to a method for making a device comprising a transponder antenna, wherein the method comprises the steps of: making an assembly including a thin substrate carrying at least one antenna, the antenna having connection end portions bearing on the substrate at substrates locations. The substrate forms or includes a sheet- or strip-like adhesive body in contact with the antenna. The invention also relates to the resulting device.

The invention relates to the field of radiofrequency transponders. It more particularly relates to a method for making a device comprising a transponder antenna connected to contact pads and the resulting device.

The above method more particularly includes a step of connecting the antenna to contact pads, with the latter being intended to be connected to a microcircuit, such as an electronic chip or a module.

The invention aims at being mainly used for making a radiofrequency electronic inlay having a low thickness, and for a low cost and preferably having good communication i.e. more particularly range properties.

Such an inlay includes at least one antenna on a substrate connected to a microcircuit. It is more particularly intended to be inserted into laminated sheets, an electronic passport cover, an identity card, any product provided with a radiofrequency communication function; and thus the thickness thereof is important.

In other cases, such as in patent EP 0880 754, the antenna wire made of a wire inlaid in a polymer sheet is laid above the contact pads of an already positioned chip or the corresponding location thereof prior to a connection by more particularly ultrasonic welding or thermo-compression bonding, directly by pressing the wire and bringing energy thereto.

The application for a U.S. Pat. No. 7,059,535 is known, wherein an antenna is made on a thin substrate with respect to covering sheets, whereas a module is on such substrate, is already known. The antenna ends are laid above the contact pads of a module and are then connected by thermo-compression. A lower covering sheet including a cavity is placed under the substrate so as to receive a portion of the module and of the substrate in the cavity, during a lamination with another upper covering sheet placed above the substrate. The substrate deforms under the module, obstructs the cavity and levels the outer face of the lower covering sheet.

This method has a drawback in that it is inconvenient for placing the module in the cavity and the thinness of the final product is not optimum.

The application for patent EP-2001077 (A1) is known, which discloses a blind connection of a module using thin anvils and weld probes, with the module being positioned in a cavity in an antenna support. As regards the connection, anvils go through the antenna support which is composed of a fabric antenna substrate and a reinforcing material under the antenna substrate. The welding operation implements an anvil (E) which bears against the embedded antenna end portion in the substrate. The anvil makes a hole in the support opposite the end portion to be connected so that the portion to be connected is supported by the anvil during the welding.

The perforations made by the thin anvils in the reinforcing material may cause visible surface unevenness on the end product, depending on the considered applications, more particularly when such reinforcing material forms a passport cover.

The invention aims at remedying the above mentioned drawbacks.

The principle of the invention consists in making the antenna on a thin substrate forming at least most of a sheet- or strip-like adhesive body which will be used for assembling covering sheets. An electronic module is also positioned and connected on the substrate. The possible marks caused by such positioning and/or connection of the module are thus invisible after adding covering sheets. The material of the thin substrate is preferably selected with properties enabling the decomposition thereof in case of a fraudulent handling such as the replacement of covering sheets.

For this purpose, the object of the invention is a method for making a device comprising a transponder antenna, with said method comprising the steps of:
making an assembly including a substrate (2) carrying at least one antenna (3), the antenna comprising connection end portions (7b, 8b) bearing on the substrate at substrates locations,

characterized in that the substrate forms or includes a sheet- or strip-like adhesive body in contact with the antenna.

According to one characteristic, the thickness of the sheet or strip is less than 90 μm.

Another object of the invention is the device resulting from the method and a radiofrequency communication electronic device, such as a contactless chip card, a passport including such device.

According to other characteristics of the invention:
at least one covering sheet or layer covers one face or the two opposite faces of the substrate;
at least one of the covering sheets or layer includes a microcircuit thickness compensation opening;
the antenna wire and the connection end portions thereof are at least partially embedded in the web adhesive substrate between two covering sheets;
the adhesive material has sufficiently poor mechanical behaviour properties to decompose in case of an attempted delamination/tearing of the covering sheets, for replacing these by other non genuine sheets.

In this case, the antenna may deform and be detuned, thus adding a safety aspect to the device.

Other characteristics and advantages of the invention will appear when reading the following description which is given as an illustrative and not restrictive example, and referring to the appended drawings, wherein:

FIG. 1 illustrates a partial schematic view of a device according to the invention in the manufacturing process, which can be obtained according to one embodiment of the method according to the invention;

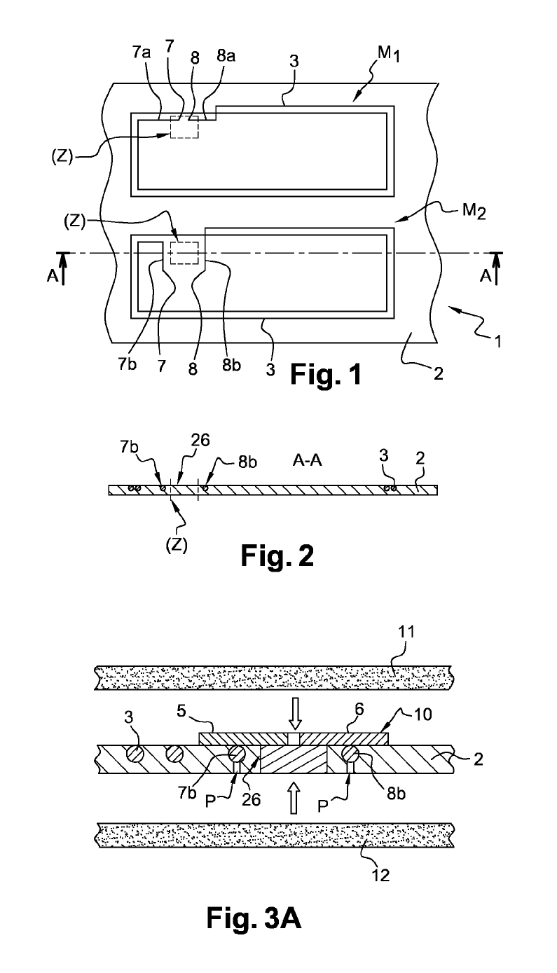

FIG. 2 illustrates a sectional view along A-A in FIG. 1;

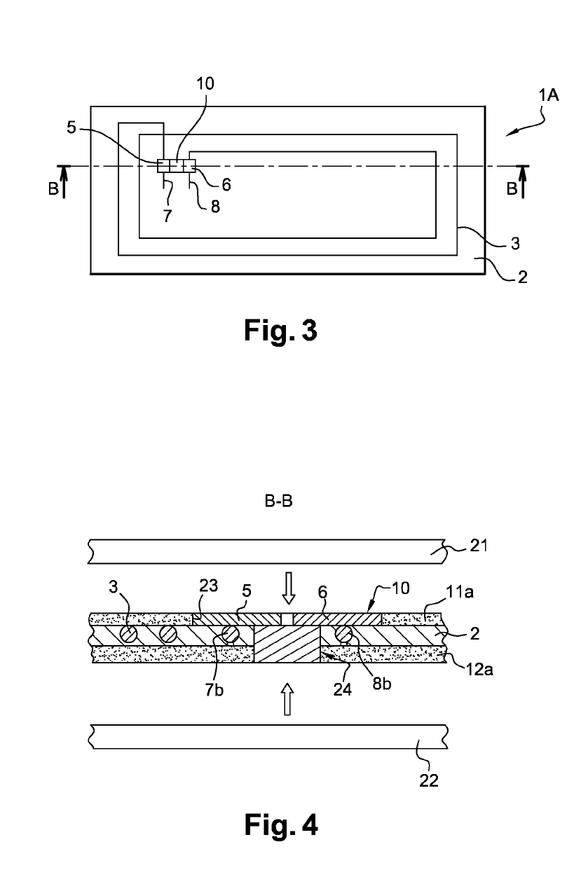

FIG. 3 illustrates a schematic view of a transponder which can be obtained according to one embodiment of the method according to the invention;

FIG. 3A illustrates a sectional view of a device along section B-B in FIG. 3;

FIG. 4 illustrates a sectional view of a device along a similar cut as the preceding one, but with module thickness compensation sheets including openings for receiving a part of the module;

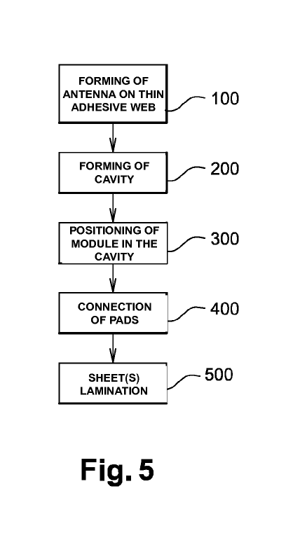

FIG. 5 illustrates steps of a method according to a preferred embodiment of the invention.

FIG. 1 illustrates a schematic view of a device 1 including a substrate 2 carrying at least one antenna 3, with the antenna comprising connection end portions 7a, 8a, 7b, 8b bearing on the substrate at substrates locations.

In the example, the substrate is a continuous strip or a sheet including a plurality of antennas formed by inlaying a conducting wire into the substrate material.

According to the invention, the substrate is made of a sheet- or strip-like adhesive body. In the chip card, passport, inlay applications, the thickness of the adhesive is preferably less than 100 μm, or even 90 μm. More exactly, a thickness between 60 and 80 μm is preferred. In other alternative utilisations, the thickness exceeds 100 μm, and is for instance 150 or 200 μm.

Depending on the nature of the adhesive, it may be more practical to use a film supporting the latter, with a thickness of less than or equal to 80 μm in order to facilitate handling operations. Such support film is subsequently removed as mentioned herein. The adhesive body is thus in contact with and supports the antenna.

The adhesive material is for instance a PU thermo-adhesive supplied by the “Bayer-Epurex” company. Other materials are suitable, such as for instance polyethylene-based adhesive (EVA type).

Definition of adhesive body according to a preferred embodiment:

The adhesive is more particularly a thermo-fusible material, without however excluding heat-melting materials. It may include molecules having polar groups to ensure a correct adherence with various materials therethrough. A mechanical catching, more particularly in pores of a covering sheet, is not necessary to provide the adherence, unlike U.S. Pat. No. 7,059,535.

The adhesive more particularly includes materials of the hot melt glue type.

The selected adhesive preferably has a softening temperature of approximately 90 to 110° C. Such temperature corresponds to the temperature of implementation or activation of the adhesive for the lamination with covering sheets.

The adhesive has a softening temperature clearly lower than that of the covering sheets which is, for instance, above 160° C.

According to one characteristic, the adhesive material has sufficiently poor chemical behaviour properties to decompose/tear in case of an attempted delamination of the covering sheet. The antenna wire is preferably totally or partially embedded in the adhesive body.

The substrate thus fraudulently handled loses its integrity and its dimensional stability and the antenna also loses its dimensional stability accordingly and gets detuned.

The properties of the material are so selected that it has a sufficient resistance to be handled and to support an antenna, more particularly during the step of inlaying an antenna (with or without a removable support film, with the antenna being positioned in contact with the adhesive body).

The material is preferably able to decompose in case of a fraudulent delamination of covering sheets glued together via the substrate and no longer forms a stable support for the antenna. The adhesive body preferably has sufficiently poor mechanical and/or chemical behaviour properties to decompose or to tear in case of an attempted delamination of the covering sheet, more particularly by etching. The etching may consist in delaminating, more particularly using a solvent.

According to one characteristic, the device includes a cavity 26 close to the connection end portions 7b, 8b. In the example (FIG. 1) in the antenna pattern M1, the start 7 and end 8 points of the antenna are positioned in the electronic module area or an area Z intended to be subsequently cut.

On the contrary, in the antenna pattern M2 of FIG. 1, the start 7 and end 8 points of the antenna are positioned out of the area Z, but close to the location of a cavity and/or the module, however.

According to one characteristic, the device 1A (FIG. 3A) in a more advanced manufacturing step than in FIG. 1, includes an electronic module 10 placed at least partially in the cavity: the module includes contact pads 5, 6 respectively connected to the connection end portions 7b, 8b of the antenna which are positioned directly opposite these.

The module may be an integrated circuit component or chip and the contact pads may be the bump contacts of such chip or component. Alternately, the component may be placed by a “flip-chip” on the connection end portions.

The device preferably includes at least a covering sheet or layer 11, 12 covering one face or the two opposite faces of the substrate. According to one characteristic, at least one covering sheet or layer includes a microcircuit thickness compensation opening. In the example of FIG. 4, the two sheets or layers 11a, 12a respectively include a cavity for the contact pads 5, 5 and for coating 24 the module integrated circuit chip.

In FIGS. 3, 3A, the antenna wire 3 and the connection end portions 7b, 8b thereof are at least partially embedded in the web adhesive substrate 2.

The end portions are connected to the contact pads at the interface formed by the module contact pads and the substrate. A perforation P opening onto the lower surface of the substrate and providing a connection using a thin anvil (or a support needle) is provided under the portions 7b and 8b.

In FIG. 4, the antenna wire 3 and the connection end portions 7b, 8b thereof are at least partially embedded in the web adhesive substrate between two covering sheets 11a, 12a. As for the connection end portions 7b, 8b of the antenna, these are sandwiched between a covering sheet 12a and a contact pad 5, 6 of the module.

At least one of the covering sheets or layer 21, includes an opening 23, 24 for compensating a part of the module thickness.

The invention thus offers the advantage of avoiding a thickness of the conducting wire outwards, as in the patent application U.S. Pat. No. 7,059,535-B2 when the wire is connected after having overlaid a contact pad of a module.

While referring to FIG. 5, a preferred embodiment of the method according to the invention is now disclosed.

In step 100, the method for making a device including a transponder antenna includes a step of forming at least one antenna.

An assembly is thus made, which includes a substrate 2 carrying at least one antenna 3 and connection end portions (7a, 8a, 7b, 8b) bearing on the substrate at substrate locations. In other alternative embodiments of the antenna, the portions of wires intended for receiving the connections of a microcircuit may not bear on the substrate. This may more particularly be the case when the portion extends on a cavity already formed in the substrate, wherein a microcircuit is already positioned.

In the example, a continuous strip supplied in a reel with one or several antenna rows 3, with all these having the same pattern or not (FIG. 1), is used. The strip has a thickness equal to 80 μm.

Each antenna is preferably made by inlaying a conducting wire on the substrate. The conducting antenna wire may include at least one insulating coating on the whole surface thereof. The antenna has a plane spiral shape, with spaced windings.

However other, more particularly wire techniques, must not be excluded. The invention more particularly provides to deposit a heated conducting wire so that it adheres onto the substrate, or to etch a conducting strip previously fixed to the adhesive strip.

In the following step 200, the method includes a step of forming a cavity close to the connection end portions as already explained in FIG. 2. The cavity is made by punching but a compression forming or punching or any other at least partial machining of the substrate could be considered.

Alternately, when the pattern is of the M1 type the cavity forming operation is taken advantage of to cut at least a start 7 and end 8 portion of the antenna run which is in area Z.

In step 300 of module positioning, electronic modules 10 are at least partially inserted into each cavity 26. Each module includes contact pads positioned opposite the antenna connection end portions 7b, 8b.

In step 400 of connection, the method makes the connection of the contact pads with the end portions. The connection is thus obtained by a thermo-compression or ultrasonic welding 38. The welding uses an anvil E (not shown) which bears against the embedded antenna end portion in the support. Each weld forms a connection point on the connection end portions and the contact pads.

Other connections are possible, more particularly using conducting glue placed on bare areas of the antenna connection portions.

The method complies with the one disclosed in the patent application EP-2001077-A1: the anvil makes a perforation P in the substrate 2 opposite the end portion to be connected so that the portion 7b, 8b to be connected is supported by the anvil during the welding operation.

In step 500 of lamination, the method provides for the covering of one face or the two opposite faces of the substrate with a covering sheet 11, 12 or layer. If need be, at least one of the covering sheets 11a, 12a or layer includes a microcircuit thickness compensation opening 23, 24.

Then, cuts are made according to the required format. If need be, the cut according to the format may be executed in other steps.

1. A method for making a device comprising a transponder antenna, said method comprising:
making an assembly including a substrate carrying at least one antenna, the antenna comprising connection end portions bearing on the substrate at substrates locations, and
wherein the substrate forms or includes a sheet- or strip-like adhesive body in contact with the antenna.

2. A method according to claim 1, wherein the substrate has a thickness of less than 90 μm.

3. A method according to claim 1, further including a step of forming a cavity close to the connection end portions locations.

4. A method according to claim 3, wherein the step of forming a cavity includes the cutting of a least a start and/or an end portion of an antenna run.

5. A method according to claim 3, further including a step of inserting an electronic module at least partially into the cavity, with said module including contact pads positioned opposite the connection end portions of the antenna.

6. A method according to claim 3, further including a step of connecting the contact pads corresponding to the connection end portions after insertion into the cavity.

7. A method according to claim 1, wherein the adhesive is used at a softening temperature of approximately 90 to 110° C.

8. A device including a substrate carrying at least one antenna, with the antenna comprising:
connection end portions bearing on the substrate at substrates locations, wherein the substrate forms or includes a sheet- or strip-like adhesive body in contact with the antenna.

9. A device according to claim 8, wherein the substrate has a thickness of less than 90 μm.

10. A device according to claim 8, wherein the antenna with the connection end portions thereof is made by inlaying wire into the substrate.

11. A device according to claim 8, further including:
a cavity close to the connection end portions locations, and
an electronic module at least partially positioned in the cavity, with said module including contact pads positioned opposite connection end portions of the antenna.

12. A device according to claim 11, wherein the antenna wire and the connection end portions thereof are at least partially embedded in the adhesive substrate.

13. A device according to claim 8, wherein the adhesive body has sufficiently poor mechanical and/or chemical behaviour properties to decompose or to tear in case of an attempted delamination of the covering sheet.

14. A device according to claim 8, wherein the adhesive has a softening temperature of approximately 90 to 110° C.

15. A radiofrequency communication electronic device, including the device according to claim 8.

16. The radiofrequency communication electonic device of claim 15, wherein the device is a contactless chip card.

17. The radiofrequency communication electronic device of claim 15, wherein the device is a passport.
